(19) United States
(12) Patent Application Publication
(10) Pub. No.: US 2021/0387473 A1
(43) Pub. Date: Dec. 16, 2021

(54) ADJUSTABLE AIRLESS TIRE SYSTEM WITH CHANGEABLE SUPPORTING STRUCTURES

(71) Applicants: Hai Huang, (US); Tony Huang, (US)

(72) Inventors: Hai Huang, Herndon, VA (US); Tony Huang, Herndon, VA (US)

(73) Assignees: Hai Huang, Herndon, VA (US); Tony Huang, Herndon, VA (US)

(21) Appl. No.: 17/399,122

(22) Filed: Aug. 11, 2021

Related U.S. Application Data
(63) Continuation-in-part of application No. 16/137,436, filed on Sep. 20, 2018.
Application No. 16/137,436 is a continuation-in-part of application No. 16/183,681, filed on Nov. 7, 2018.
Application No. 16/183,681 is a continuation-in-part of application No. 16/416,069, filed on May 17, 2019.
Application No. 16/416,069 is a continuation-in-part of application No. 16/752,658, filed on Jan. 26, 2020.
Application No. 16/752,658 is a continuation-in-part of application No. 16/823,202, filed on Mar. 18, 2020.

(51) Int. Cl. B60B 9/26; B60C 7/14

(52) U.S. Cl. CPC B60B 9/26; B60C 7/146; B60B 2900/131; B60B 2900/551; B60B 2900/211

(57) ABSTRACT

An adjustable airless tire system with changeable supporting structures optimizes the contradictory relationship between a suspension potential and a tension of a tire according to changes of road conditions. The changeable supporting structures can be selected from one of three separated and compatible parts, including metallic rods, or springs or spring-loaded shock absorbers according to customer's requirements and usage of a vehicle. A metallic cable is used to maximize the suspension potential of the tire and a control component is used to regulate the tension of the tire. A curved tire forms a closed space between the tire and a rim to prevent foreign objects from sticking between them. Therefore, the invention possesses advantages of oil efficiency, affordability, comfortability, controllability and safety.

### FIELD OF THE DISCLOSURE

The present disclosure generally relates to the field of an adjustable airless tire system with changeable supporting structures to support tires and absorb impact energy, and a metallic cable to transfer shock impulses of a rough road from the changeable supporting structures of a ground contact surface of the tire to other changeable supporting structures within the tire, and a control component to regulate a tension and a size of the ground contact surface of the tire according to road conditions, which possess its advantages of oil efficiency, comfortability, controllability and safety.

### BACKGROUND

Current internal inflated tire uses elasticity of whole wall of the tire to provide suspension potential for a vehicle by transferring shock impulses of a rough road from a ground contact surface of the tire to the wall of the tire through air within the tire. The suspension potential provided by elasticity of the wall of the tire absorbs and temporarily stores the impact energy, which reduces impacts on the vehicle. But the stored impact energy will be immediately released and fast rebound the compressed tire, which may vibrate the vehicle or even push the tire off the ground like a rebounded basketball and make the vehicle difficult to handle. Another disadvantage for the internal inflated tire is air leaking if the tire is penetrated by sharp materials.

Nowadays, there are many types of airless tires. But they just absorb the impact energy from the ground contact surface of the tires and cannot efficiently transfer the impact energy to other parts of the tires; they also need special materials that must have enough hardness to support the weight of the vehicle as well as enough elasticity to provide the suspension potential for the vehicle. But there is contradictory relationship between hardness and elasticity of the tire, which compromise their functions. Increased hardness of the materials reduces the elasticity, which decreases its suspension potential, and increased elasticity of the materials generates greater ground contact surface of the tires, which increases its rolling resistance and consumes more oil. Increased rolling resistance also increases temperature of the tire and generates noses and instability, which limit high speed performance of the tires. In addition, they are made of special materials, which are more expensive.

Road conditions may be different, such as a rough road or slippery one, which need different tension and size of the ground contact surface of the tire to keep comfortability, stability, and safety during driving. But it is not easy for current tires to adjust the tension and the size of the ground contact surface of the tire according to changes of the road conditions.

The invention uses changeable supporting structures, a metallic cable, and a control component to regulate the tension and the size of the ground contact surface of the tire, which optimizes the contradictory relationship between hardness and suspension of the tire according to changes of road conditions. So, the adjustable airless tire system in the invention improves ride quality and vehicle handling, which possess the advantages of oil efficiency, affordability, comfortability, controllability and safety.

### BRIEF SUMMARY OF THE DISCLOSURE

The present disclosure includes an adjustable airless tire system with changeable supporting structures. The changeable supporting structures can be selected from one of three separate and compatible supporting parts, including supporting rods, or springs, or spring-loaded shock absorbers according to customer's requirements and usages of a vehicle.

A metallic cable transfers the impact energy from the changeable supporting structures of a ground contact surface of the tire to other changeable supporting structures within the tire to maximize their suspension potential to absorb the impact energy.

A control component will regulate extension of the metallic cable to regulate a tension and a size of the ground contact surface of the tire according to road situations, which improve its fuel economy, comfortability, controllability and safety during driving.

Utilizing elastomer as similar as current internal inflated tires, the adjustable airless tire is economic and affordable. Its curved shape provides a closed space between the tire and a rim of a wheel to prevent foreign objects from sticking between them.

Other aspects or embodiments of the present disclosure can be understood by those skilled in the art in light of the description, the claims, and the drawings of the present disclosure.

### BRIEF DESCRIPTION OF THE DRAWINGS

The following drawing is merely an example for illustrative purposes according to various disclosed embodiments and is not intended to limit the scope of the present disclosure.

FIG. 1 is a view schematically showing an adjustable airless tire system with changeable supporting structures related to the present invention; and

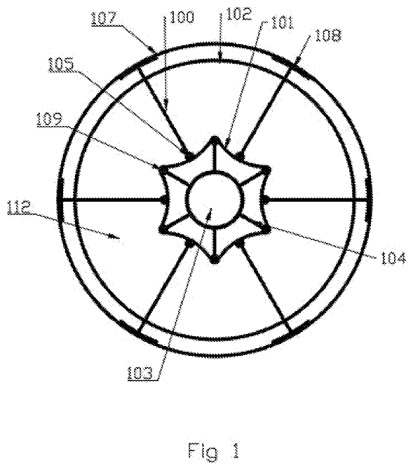

FIG. 2 is a cross-sectional view of the changeable supporting structures supporting a tread area of inner side of the tire with a curved plate at one end and contacting with a metallic cable with a bearing at another end, and the curved tire forming a closed space with a rim of a wheel; and

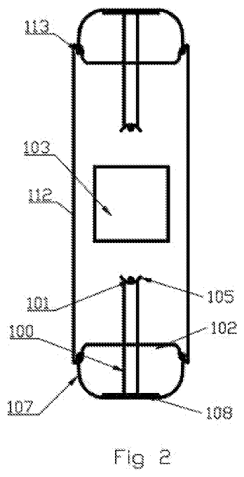

FIG. 3 is a cross-sectional view of control rods supporting the metallic cable with a bearing at one end and controlled by a control component at another end; and

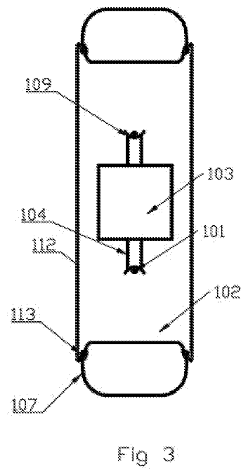

FIG. 4 is a partial enlarged view of a gear within the control component regulating inward or outward movement of the control rods; and

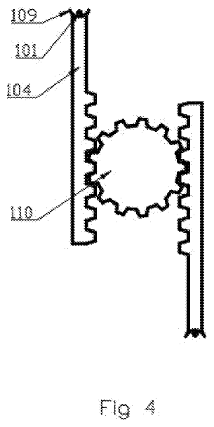

FIG. 5 is a partial enlarged view of separated and compatible supporting parts of supporting rods, springs, and spring-loaded shock absorbers.

### DETAILED DESCRIPTION

Reference will now be made in detail to exemplary embodiments of the disclosure, which are illustrated in the accompanying drawing. Wherever possible, the same reference numbers will be used throughout the drawing to refer to the same or like parts.

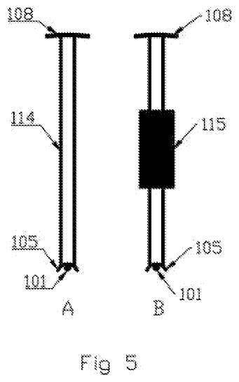

The invention contains changeable supporting structures 100 to support a weight of a vehicle and provide suspension to absorb impact energy from a tire 107. A plurality of spoke structure of the changeable supporting structures 100 radially extend between a metallic cable 101 and a tread area of inner side of the tire 107. One end of the changeable supporting structures 100 close to the tread area of the inner side of the tire 100 is fixed with a shaped plate 108 to fit with the curved inner side of the tire 107, and another end of the changeable supporting structures 100 is fixed with a bearing 105 that contact with the metallic cable 101 to smooth its movement. The changeable supporting structures 100 can be selected from one of three separated and compatible supporting parts, including metallic rods (A in FIG. 5), or springs, or spring-loaded shock absorbers (B in FIG. 5). 114 in FIG. 5A represents the metallic rods and 115 in FIG. 5B represents the springs or the spring-loaded shock absorbers, which is located within the wheel 112. The three separated and compatible supporting parts contain their individual advantages and disadvantages: (1) the metallic rods 114 are simpler, lighter, and cheaper, but unable to provide additional suspension potential. The suspension potential will come only from elasticity of the tire; (2) the springs 115 with rod part on each end connect with the plate 108 or the bearing 105. The spring 115 provide additional suspension potential but increase a weight of a wheel and generate spring oscillation, which will vibrate the vehicle; (3) the spring-loaded shock absorbers 115 are made of a coil spring and a nested cylindrical tube of a shock absorber with rod part on each end to connect with the plate 108 or the bearing 105. The spring-loaded shock absorbers provide additional suspension potential and damp the spring oscillation, which keep the tire 107 in contact with the ground at all time to reduce the effect of traveling over rough ground and improve ride quality and vehicle handling, but they are more expensive and heavier. So, selecting which type of the changeable supporting structures 100 is based on customer's requirements and usages of a vehicle. For example, using the changeable supporting structures with additional suspension potential will benefit the vehicle to drive on the rough ground.

The invention contains the metallic cable 101 to transfer the impact energy from the changeable supporting structures 100 of the ground contact surface of the tire 107 to other changeable supporting structures 100 within the tire 107 to maximize their suspension potential to absorb the impact energy. The metallic cable 101 pushes the changeable supporting structures 100 outward to support a tread area of the inner side of the tire 107. As the ground contact surface of the tire 107 compress the corresponding changeable supporting structures 100, they will compress a corresponding section of the metallic 101 inward. The inward metallic cable 101 will tighten other sections of the metallic cable 101, which push other changeable supporting structures 100 outward to compress other tread area of the inner side of the tire 107. By this way, the impact energy is transferred from the changeable supporting structures 100 of the ground contact surface of the tire 107 to other changeable supporting structures 100 within the tire 107 through the metallic cable 101, which maximize their suspension potential to absorb the impact energy.

The invention contains a control component 103 located at a hub area of a wheel 112 to regulate a tension and a size of the ground contact surface of the tire 107 according to road conditions. The control component 103 includes control rods 104. A bearing 109 is fixed at its one end of the control rods 104 to smooth its movement on the metallic cable 101. Another end of the control rods 104 is toothed part, which meshes with a gear 110 within the control component. Turning the gear 110 can extend or withdraw the control rods 104 outward or inward the control component 103 to regulate extension of the metallic cable 101, which decides the tension and the size of the ground contact surface of the tire 107 according to the road conditions. Increasing the tension of the tire 107 will reduce the size of the ground contact area of the tire 107, which reduces rolling resistance of the tire 107. But it also reduces the suspension potential of the tire 107. From another way, reducing the tension of the tire 107 will increase the suspension potential of the tire 107. But it also increases the size of the ground contact area of the tire 107 and the rolling resistance. As a result, regulating the tension of the tire 107 will improve fuel efficiency, comfortability, controllability and safety during driving. First, driving on an even road, regulating the tension of the tire 107 can optimize the size of the ground contact surface of the tire 107 with the road, which will reduce the rolling resistance to improve fuel efficiency and especially reduce a temperature and noses and instability of the tire 107 at high speed driving; second, driving on a rough road, reducing the tension of the tire 107 will increase suspension potential of the changeable supporting structures 100, which creates a softer ride to improve the comfortability; third, driving on a slippery road, such as raining, icy or snowing, decreasing the tension of the tire 107 will increase the size of the ground contact surface of the tire 107 with the road, which improves the controllability and safety of the vehicle during driving; fourth, driving on sand or mud terrain, increasing the size of the ground contact surface of the tire 107 will decrease pressure of the tire 107 on the ground, which reduces sinking of the tire 107 into sand or mud. It also improves traction of the tire 107 over loose ground surface; and fifth, at emergency braking, the increased size of the ground contact surface of the tire 107 will increase frictional resistance between the ground and the tire 107 to decrease braking distance for lifesaving.

The tire 107 is made of elastomer that is similar as current internal inflated tires. Its cross section of the tire 107 is curved as the internal inflated tires to form a closed space between the tire 107 and a rim 102 of the wheel with its two sides mounted within a rim groove 113 of the wheel 112. The rim groove 113 is used to fix the tire 107 with the rim 102, which prevents foreign objects from sticking between the rim 102 and the tire 107 to improve driving quality and safety.

Other applications, advantages, alternations, modifications, or equivalents to the disclosed embodiments are obvious to those skilled in the art and are intended to be encompassed within the scope of the present disclosure.

1. An adjustable airless tire system with changeable supporting structures comprising:
changeable supporting structures supporting a weight of a vehicle and providing a suspension potential to absorb impact energy; and
a metallic cable maximizing the suspension potential to absorb the impact energy by transferring the impact energy from the changeable supporting structures of a ground contact surface of a tire to other changeable supporting structures within the tire; and
a control component regulating a tension and a size of the ground contact surface of the tire through control rods according to road conditions; and
the tire forming a closed space between the tire and a rim of a wheel to prevent foreign objects from sticking between the rim and the tire.

2. The adjustable airless tire system according to claim 1, further comprising a plurality of spoke structure of the changeable supporting structures extending between the metallic cable and a tread area of an inner side of the tire, wherein one end of the changeable supporting structures close to the tread area of the inner side of the tire is fixed with a shaped plate to fit with the tread area of the inner side of the tire and another end of the changeable supporting structures is fixed with a bearing to contact with the metallic cable.

3. The adjustable airless tire system according to claim 2, further comprising selecting one of three separated and compatible supporting parts as the changeable supporting structures, which include metallic rods, or springs, or spring-loaded shock absorbers with their individual advantages and disadvantages.

4. The adjustable airless tire system according to claim 3, wherein the metallic rods are simpler, lighter, and cheaper, but are unable to provide additional suspension potential.

5. The adjustable airless tire system according to claim 3, wherein the springs are located within the wheel with a rod on each end to fix with the shaped plate or the bearing, the springs provide additional suspension potential but increase a weight of the wheel and generate spring oscillation to vibrate the vehicle.

6. The adjustable airless tire system according to claim 3, wherein the spring-loaded shock absorbers are made of a coil spring and a nested cylindrical tube of a shock absorber with a rod on each end to fix with the shaped plate or the bearing, the spring-loaded shock absorbers are located within the wheel and provide additional suspension potential and damp the spring oscillation but are more expensive and heavier.

7. The adjustable airless tire system according to claim 1, further comprising the metallic cable to maximize the suspension potential of the tire, wherein the metallic cable pushes the changeable supporting structures outward to support the tread area of the inner side of the tire, and the impact energy will be transferred from the changeable supporting structures of the ground contact surface of the tire to other changeable supporting structures within the tire through the metallic cable to maximize the suspension potential.

8. The adjustable airless tire system according to claim 1, further comprising the control component optimizing contradictory relationship between the suspension potential and the tension of the tire, wherein the control component contains the control rods to regulate the tension of the tire, outside end of the control rods is fixed with a bearing to support the metallic cable and inside end of the control rods contains a toothed part to mesh with a gear within the control component to regulate outward or inward movements of the control rods, Turning the gear to push the control rods outward against the metallic cable will push the changeable supporting structures outward against the tread area of the inner side of the tire, which increases the tension of the tire to reduce the suspension potential of the tire and the size of the ground contact area of the tire; or turning the gear to withdraw the control rods inward will decrease the tension of the tire, which increases the suspension potential of the tire and the size of the ground contact area of the tire.

9. The adjustable airless tire system according to claim 1, wherein the tire is made of elastomer and a cross-sectional view of the tire is curved with its two sides of the tire mounted within a rim groove of the wheel, the rim groove is used to fix the tire with the rim, which makes a closed space between the tire and the rim to prevent foreign objects from sticking between them.
